(19) United States
(12) Patent Application Publication
(10) Pub. No.: US 2024/0062375 A1
(43) Pub. Date: Feb. 22, 2024

(54) IMAGE ANALYSIS PROCESS OF MICROPHYSIOLOGICAL SYSTEMS

(71) Applicant: ARACARI BIOSCIENCES, INC., Irvine, CA (US)

(72) Inventors: R. Hugh F. Bender, Irvine, CA (US); Ivan Chang, Irvine, CA (US); Christopher C.W. Hughes, Irvine, CA (US); Duc T.T. Phan, Irvine, CA (US); G. Wesley Hatfield, Irvine, CA (US)

(21) Appl. No.: 18/453,541

(22) Filed: Aug. 22, 2023

Related U.S. Application Data
(60) Provisional application No. 63/373,131, filed on Aug. 22, 2022.

(51) Int. Cl. G06T 7/00; G06T 7/11; G06T 7/194

(52) U.S. Cl. CPC G06T 7/0012; G06T 7/11; G06T 7/194; G06T 2207/10064; G06T 2207/30096; G06T 2207/30024; G06T 2207/10056; G06T 2207/20081; G06T 2207/30101

(57) ABSTRACT

A method for image-based data collection and analysis of a tissue sample comprising a tumor or permeable microchannels to simulate blood vessels. The method may comprise providing a microfluidic platform to hold the tissue sample or microchannels. The method may further comprise providing an imaging system capable of processing fluorescent images and directing a fluorescent dye through the microfluidic platform to illuminate the tumor or microchannels. The method may further comprise the imaging system capturing a plurality of fluorescent images of the tissue sample over a period of time. The method may further comprise a computing device processing the plurality of fluorescent images and determining a plurality of parameters based on the images.

### CROSS-REFERENCES TO RELATED APPLICATIONS

This application is a non-provisional and claims benefit of U.S. Provisional Application No. 63/373,131 filed Aug. 22, 2022, the specification of which is incorporated herein in its entirety by reference.

### FIELD OF THE INVENTION

The present invention is directed to image-based data collection and analysis of vascularized microphysiological systems (MPS) and/or organ-on-a-chip systems for simulation of in vivo conditions and processes.

### BACKGROUND OF THE INVENTION

The challenge to create a microenvironment enabling growth of an in vitro microtissue perfused with living microvessels (e.g., arterioles, capillaries, and venules) represents a completely new paradigm in the creation of 3-D tissues. By definition, a 3-D tissue requires enhanced transport of nutrients and waste relative to 2-D monolayer cultures. Current approaches to create such an environment have employed three primary approaches: 1) enhanced concentration gradients of nutrients and waste while relying on molecular diffusion (Brownian motion) as the mode of transport, 2) the creation of microchannels in the tissue to enhance advection (forced convection), or 3) forced interstitial fluid flow. In vivo, diffusion of nutrients and waste is the mechanism of transport once solutes exit the capillary bed, and is generally limited to distances <250 μm. The rate of transport is proportional to the concentration difference between two points, and inversely related to the separation distance. Hence, numerous 3-D tissue models have been reported with dimensions on the order of 1-10 mm by simply enhancing the oxygen tension (room air is 160 mmHg compared to 20-30 mmHg in the interstitial tissue) and concentration of other nutrients (e.g., glucose).

More recently, microfabrication technology has led to the creation of precise microchannels on non-biological substrates (e.g., silicon or polydimethylsiloxane, PDMS) or within biological substrates such as collagen. While these approaches offer the distinct advantage of introducing advection as a mechanism of transport, even when “endothelialized”, the channels are not living microvessels. Hence, while this approach may assist the creation of larger engineered tissues, they are of less benefit in understanding in vivo biological functions such as angiogenesis, cell migration, cell differentiation, and ischemia.

Vascularized microphysiological systems (MPS) and organ-on-a-chip systems are often utilized in medical and physiological studies for 3-dimensional visualization of living tissue. These systems implement microfluidics and tissue engineering to accurately simulate in vivo structures to allow researchers to see how tissue is affected by certain conditions, processes, diseases, etc. However, present systems for simulating living tissue behavior are artificial in their structure, thus limiting the similarities between simulated tissue behavior and in vivo tissue behavior. For example, prior systems for blood vessel visualization simulated blood vessel structure with a plurality of artificial tube-like structures that may be lined with endothelial cells (cells that form the inner wall of a blood vessel). These tube-like structures are filled with fluorescent dye in order to image the blood vessel structures. However, these systems are unable to simulate the permeability of in vivo blood vessels. Thus, there exists a present need for a vascularized MPS/organ-on-a-chip system capable of organically simulating living tissue behavior for imaging purposes.

### BRIEF SUMMARY OF THE INVENTION

It is an objective of the present invention to provide methods that allow for image-based data collection and analysis of vascularized microphysiological systems (MPS) and/or organ-on-a-chip systems for simulation of in vivo conditions and processes. Embodiments of the present invention can be freely combined with each other if they are not mutually exclusive.

The present invention is related in subject matter to the following pre-existing patents, publications, and applications: U.S. Pat. No. 9,810,685, “A High-Throughput Platform Comprising Microtissues Perfused With Living Microvessels” filed Oct. 5, 2011; U.S. Pat. No. 11,180,724 B2, “MICROFLUIDIC PRESSURE REGULATOR FOR ROBUST HYDROGEL LOADING WITHOUT BURSTING” filed Oct. 24, 2016; U.S. Publication No. 2019/0119619 A1, “MULTI-LAYERED MICROFLUIDIC SYSTEMS FOR IN VITRO LARGE-SCALE PERFUSED CAPILLARY NETWORKS” filed Oct. 22, 2018; and U.S. Application No. 63/226,069, “AN IN VITRO MICROPHYSIOLOGICAL SYSTEM OF VASOACTIVE VASCULATURE” filed Jul. 27, 2021. These patents, publications, and applications are hereby incorporated into the following specification by reference.

The present invention features systems and methods for imaging in vitro microtissue perfused with living microvessels. The potential impact of creating an in vitro microtissue perfused with living microvessels can be encompassed in the broad areas of oncogenesis, ischemia, arterio-venous malformations, wound healing, drug delivery, and tissue growth, differentiation, and death. For example, the growth and development of tumors is a 3-D process that requires the recruitment of host vessels for delivery of nutrients and metastasis of cells. All major modes of pharmacotherapy (e.g., oral, subcutaneous, intravenous, intramuscular) involve uptake and delivery of the drug by the circulatory system including microcirculation. Capillary permeability and high-throughput screening of drugs are major areas of investigation that could be addressed by the microfluidic platform Finally, the “decision” by a tissue following insult to revitalize or undergo programmed death is poorly understood, yet is fundamental for success in advancing human health, and must depend on a functional (i.e., perfused) capillary bed.

The methods and systems of the present invention implement a microfabricated platform combined with living cells and an extracellular matrix to mimic the in vivo formation of microvessels. The platform may comprise a metabolically active microtissue that receives nutrients and eliminates waste products through a living microvessel network. The platform may further comprise a direct fluidic connection between living microvessels within the device and microfluidic channels (A-V “arterio-venous” channels) within the device allowing the flow of fluid between the microfluidic channels and the microvessels. Templates for the microfluidic device may comprise materials known to those of skill in microfabrication, such as but not limited to PDMS, glass, and/or other polymer materials.

Between paired A-V (arterial and venous) microfluidic channels and connected to each by a small port is a chamber/channel in which the microtissue(s) resides (i.e. the microtissue resides in the microtissue chamber). The newly developed living microvessels, growing within the microtissue, are able to deliver fluid from said microfluidic channels, through the ports, and into said microtissues growing within the microtissue chamber. In one embodiment, endothelial cells line the microfluidic channels and microvessels may sprout from the endothelial cells inside said microfluidic channels in response to a stimulus from within the microtissues. In another embodiment, cells are placed within the microtissue compartment and microvessels may form spontaneously from the endothelial cells inside said microtissue in response to a stimulus from within the microtissues.

In one embodiment, endothelial cells line the microfluidic channels and a process for creating the microtissue perfused with living microvessels is provided wherein said microvessels sprout from the endothelial cells inside said microfluidic channels in response to a stimulus from within the microtissues.

In another embodiment, cells are placed within the microtissue compartment and a process for creating the microtissue perfused with living microvessels is provided wherein said microvessels form spontaneously from the endothelial cells inside said microtissue in response to a stimulus from within the microtissues.

In another embodiment of the second preceding paragraph, the cells that can be grown in the microtissue compartment include, but are not limited to, stem, endothelial, stromal, epithelial, neuronal, connective, myocardial, hepatic, renal, tumor, and patient-specific cells. Such cells are hereinafter referred to as “microtissue.”

The stimulus for new microvessel growth can be something added (e.g., vascular endothelial growth factor, VEGF) either to the microtissue, microfluidic channels, ports, or a combination thereof, or can be derived from the cells grown in the microtissue chamber. For example, as cancer cells grow within the microtissue compartment they will exhaust the nutrient/oxygen supply and will, in response, produce signals (e.g., VEGF) that will recruit new microvessels from the outer endothelial cell-lined microfluidic channels. This is analogous to how new vessel growth works physiologically. Accordingly, this produces new microvessels.

The stimulus for new microvessel growth can be something added (e.g., vascular endothelial growth factor, VEGF) either to the microtissue, microfluidic channels, ports, or a combination thereof, or can be derived from the cells grown in the microtissue chamber. For example, as cancer cells grow within the microtissue compartment they will exhaust the nutrient/oxygen supply and will, in response, produce signals (e.g., VEGF) that will recruit new microvessels from the outer endothelial cell-lined microfluidic channels. This is analogous to how new vessel growth works physiologically. Accordingly, this produces new microvessels.

In one embodiment, a process for creating a 3D metabolically active network of living microvessels comprises preparing a template comprising a plurality of microfluidic and microtissue channels, and providing a stimulus to said microfluidic channels, whereby the stimulus creates a 3D metabolically active network of living microvessels.

In an embodiment of the immediately preceding paragraph, the microvessels connect the microfluidic and microtissue channels and deliver fluid between said channels and/or the microvessels are formed within the microtissue.

In an embodiment of the second preceding paragraph, the microfluidic and microtissue channels comprise normal or diseased/abnormal cells. In yet another embodiment, these cells are selected from a group consisting of stem, endothelial, stromal, epithelial, neuronal, connective, myocardial, hepatic, renal, tumor heart, liver, pancreas, muscle, brain, and kidney cells.

In an embodiment of the third preceding paragraph, the cells are obtained from a human individual.

In another embodiment, an article is provided comprising a supportive structure, one or more microfluidic channels, one or more microtissue compartments, and one or more microvessels, wherein the microvessels connect said microfluidic channels and microtissue and perfuse said microtissue, thereby allowing delivery of fluid (e.g. fluorescent dye) from the microfluidic channels to the microtissues.

In an embodiment of the immediately preceding paragraph, the microvessels are metabolically active or living, and/or the microfluidic channels, microtissue, or the combination thereof, is seeded with cells obtained from an individual.

In yet another embodiment, a method of identifying a candidate drug or treatment regime is provided comprising adding a test compound into a microfluidic channel within a microfluidic device, wherein the microfluidic device comprises one or more microfluidic channels, one or more microtissue compartments, and one or more microvessels, and monitoring for beneficial changes—appropriate for the drug type screened—in the microvessels, or microtissue, or a combination thereof; or the compound's kinetics.

In an embodiment of the immediately preceding paragraph, the compound is selected from a group consisting of cancer drugs, cell proliferation drugs, and wound healing/repair drugs.

In an embodiment of the second preceding paragraph, the microfluidic channels, microtissue, or the combination thereof, are seeded with cells obtained from an individual.

The present invention also features methods and systems for image-based data collection and analysis of a tissue sample comprising a tumor. The method may comprise providing a microfluidic platform to hold the tissue sample. A structure of the microfluidic platform may affect the shape of the tumor as it grows. The method may further comprise providing an imaging system capable of processing fluorescent images and directing a fluorescent dye through the microfluidic platform to illuminate the tumor. The method may further comprise the imaging system capturing a plurality of fluorescent images of the tissue sample over a period of time. The method may further comprise a computing device processing the plurality of fluorescent images. In certain embodiments, the computing device processes the fluorescent images for identifying the shape of the tumor. In certain embodiments, the computing device is configured to determine a type of tumor by identifying the shape of the tumor. In certain embodiments, the computing device processes the fluorescent images to determine a tumor count. In certain embodiments, the computing device can determine if there is a reduction (or increase) in tumor count over a period of time. The present invention is not limited to analysis based on tumor shape and/or tumor count.

In some embodiments, the method may further comprise applying a tumor treatment to the tissue sample to determine an efficacy of the tumor treatment from how the tumor changes over time. The method may further comprise determining the growth of the tumor over time. In some embodiments, the imaging system may comprise an automated fluorescent microscope system, a plate reader with imaging capacity, or a combination thereof. Identifying the shape of the tumor may implement a machine learning algorithm trained by previous data mapping types of tumors to shapes of tumors.

The present invention features a method for image-based data collection and analysis of simulated blood vessels. The method may comprise providing a vascularized microfluidic platform with multiple permeable microchannels to act as simulated blood vessels with a permeability similar to or equivalent to that of an in vivo blood vessel. The method may further comprise providing an imaging system capable of processing fluorescent images and directing a fluorescent solution comprising one or more cells through the vascularized microfluidic platform to at least partially permeate through the plurality of permeable microchannels. The method may further comprise the imaging system capturing a plurality of fluorescent images of the plurality of permeable microchannels over a period of time, a computing device processing the plurality of fluorescent images, and determining one or more parameters selected from a group consisting of a morphology of the microfluidic platform, the permeability of each microchannel, a molecular exchange rate of each microchannel, a metabolic exchange rate of each microchannel, cell movement, and tissue infiltration of the one or more cells. Determining the tissue infiltration of the one or more cells may involve counting a number of cells adhering to a wall of each microchannel and a number of cells exiting each microchannel.

In some embodiments, the plurality of permeable microchannels may be endothelialized. The one or more cells may comprise white blood cells, metastasizing cancer cells, or a combination thereof. The imaging system may comprise an automated fluorescent microscope system, a plate reader with imaging capacity, or a combination thereof. In some embodiments, the method may further comprise simulating, in the vascularized microfluidic platform, an inflammation signal, and determining, by the computing device, a response to the inflammation signal by the cells.

One of the unique and inventive technical features of the present invention is the microfluidic platform for holding a tissue sample comprising a tumor, wherein the platform affects the shape of the tumor during a growth period. Without wishing to limit the invention to any theory or mechanism, it is believed that the technical feature of the present invention advantageously provides for the present invention to identify the specific type of tumor, track its growth over time, and track any change in geometry reduction in the size of the tumor in response to a treatment to determine the efficacy of said treatment. None of the presently known prior references or work has the unique inventive technical feature of the present invention.

Another one of the unique and inventive technical features of the present invention is the organic visualization of vessel leakage/permeability through use of a fluorescent dye. Without wishing to limit the invention to any theory or mechanism, it is believed that the technical feature of the present invention advantageously provides for the present invention to determine the molecular and metabolic exchange rate of blood vessel tissue and if the permeability is too high or too low. Additionally, the present invention is capable of accurately simulating and visualizing the way that white blood cells travel through blood vessels to reach inflamed tissue in the body in response to an inflammation signal, as well as accurately simulate and visualize metastasizing cancer cells from a tissue invading the vessel wall, traveling through the blood vessels, exiting and colonizing a new tissue site. None of the presently known prior references or work has the unique inventive technical feature of the present invention.

Another one of the unique and inventive technical features of the present invention is the implementation of a watershed imaging technique for use in tumor identification in a fluorescent image. Without wishing to limit the invention to any theory or mechanism, it is believed that the technical feature of the present invention advantageously provides for consistent, efficient, and accurate imaging of tumors in the microfluidic platform of the present invention. None of the presently known prior references or work has the unique inventive technical feature of the present invention.

Furthermore, the inventive feature of the present invention contributed to a surprising result. One skilled in the art would not expect the watershed method to be accurate enough to properly image a tumor with the accuracy of the human eye. Surprisingly, the algorithm can be adjusted by professional biologists such as particle size, object border, object centroid, image background to provide far greater accuracy to the tumor imaging process, allowing the computer to visualize the tumor as accurately as said professional biologists can. Thus, the inventive technical feature of the present invention contributed to a surprising result.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a flow chart of a method for image-based data collection and analysis of a tissue sample comprising a tumor of the present invention.

FIG. 2 shows a flow chart of a method for image-based data collection and analysis of simulated blood vessels of the present invention.

FIG. 3 shows a schematic of a system for image-based data collection and analysis of the present invention.

FIG. 4A shows a cut-away view of a microtissue compartment of the microfluidic platform implemented in the methods of the present invention.

FIG. 4B shows a top view highlighting microfluidic channels for containing the organic microvessels imaged in the present invention.

FIG. 4C shows microfluidic channels coated with collagen (I or IV) or fibronectin, seeded with endothelial cells (black dashes) which sprout into the microfluidic channels as microvessels.

FIG. 5 shows a layered view of the microfluidic platform of the present invention.

FIG. 6 shows one embodiment of a fabrication scheme for in vitro metabolically active microtissues perfused with a human microvessel bed.

FIG. 7A shows one example of a fabrication scheme/arrangement for high throughput in vitro perfused human microvessels.

FIG. 7B shows a second example of a fabrication scheme/arrangement for high throughput in vitro perfused human microvessels.

FIG. 8 shows another embodiment of a fabrication arrangement.

### DETAILED DESCRIPTION OF THE INVENTION

Following is a list of elements corresponding to a particular element referred to herein:
2 glass slide
4 sacrificial photoresist
6 lower layer
8 parylene
12 microchannels
14 polydimethylsiloxane layer
16 communication port
18 endothelial cells
20 microvessels
22 venule channels
24 arteriole channels
26 reservoirs
28 tissue
29 microtissues
30 fluidic channels
100 microfluidic platform
150 tissue sample
200 imaging system
300 computing device

The term “microvessels” or “living microvessels” as used herein include arterioles, capillaries, venules, and lymphatics vessels. These living microvessels produced by the various embodiments connect the microfluidic channels to the microtissue. These microvessels are formed within the “pores” structures/channels located within the microfluidic channels. They are metabolically active.

The term “microfluidic channels” as used herein refer to the disclosed supplying channels, with respect to supplying or removing material from the microtissue compartment. “Arterioles” supply nutrients/fluid etc. to the microtissue; whilst “Venules” remove nutrients/fluid from the microtissue. These microfluidic channels are created by microfabrication technology and are not considered “3-D metabolically active” or living vessels.

The term “microtissue compartment” as used herein refers to a location where cells are grown. This term includes embodiments where microtissues are grown in channels rather than in closed and isolated compartments.

The term “stimulus” refers to a condition that can be induced both mechanically (interstitial flow and pressure) or chemically (e.g., growth factors (e.g., VEGF), pH, or hypoxia) or any combination thereof, which is applied to the microfluidic channel (or cells thereof). The stimulus can also be generated/produced by the cells within the microfluidic channels themselves or from the microtissue channels (and cells thereof).

The term “fluid” as used herein refers to a liquid that is able to flow. The liquid can be blood, saline, buffer, culture media, or any other solvent or media, whether the liquid is native or artificially produced.

The ability of the microvessels and microfluidic channels to be able to deliver fluid can be assessed using various methods known to those of skill in the art, including but not limited to, imaging fluorescent molecules (e.g., different molecular weight fluorescent dextrans) or fluorescent microcarrier beads (diameter less than the diameter of the pore and microvessel) that have been initially placed in the microfluidic channel.

The term “normal” in the context of “normal cells” refers to cells that are considered disease-free, whether they are obtained from disease-free or asymptomatic human individuals or animals.

The term “diseased” or “abnormal” in the context of “diseased/abnormal cells” refers to cells obtained from human individuals or animals who suffer from an illness or disease known to those of skill in the art. These diseases include but are not limited to cancers, infectious diseases, bacterial diseases, neuropathy, cardiovascular disease, nephropathy, inflammatory diseases (inflammatory bowel disease (including Crohn's disease and ulcerative colitis), asthma, dermatitis, arthritis, myasthenia gravis, Grave's disease, multiple sclerosis, and psoriasis), neurological diseases (Alzheimer's, . . . )

The term “Drug” as used herein refers to any known compound or composition, or a combination thereof, that is used to treat any disease (as referred to above). Such drugs are well known to those of skill in the art. The term also refers to compounds or compositions which are considered candidate “drugs.”

The term ‘beneficial’ as used in this application in the context of ‘beneficial effect’ of a cancer drug means a desired effect on either the microvessels or microtissues as deemed appropriate to those of skill in the art, which can include but is not limited to, a reduction in growth rate; reduction in the overall mass of the cancerous cells; an increase in a number of normal versus abnormal cells or microvessels within the microtissue; apoptosis of the cells; a change in the function of the cells; or any combination thereof.

Generating the 3-D perfused human microvessel bed (the microfluidic platform of the present invention) combines 3-D cell culture and microfabrication technology and includes not only the flexibility for high-throughput design drug screening for therapeutics and toxicity but also real-time monitoring. The overall strategy is biology-directed and inspired by the in vivo steps of angiogenesis and vasculogenesis. A minimal architecture (i.e., matrix, angiogenic stimuli) is supplied, and the endothelial cells are allowed to create a network of microvessels to meet metabolic needs. In brief, human endothelial cells are allowed to form a microvessel network within a microtissue in response to normal or pathologic angiogenic stimuli. The angiogenic stimuli initially may be some added growth factors in the fluid in the A-V (arteriole-venule) microfluidic channels, but eventually, the cells in the microtissue chamber may produce the angiogenic growth factors/stimuli. In another embodiment, the stimuli may be present simultaneously in the A-V microfluidic channels and microtissue chamber. In yet another embodiment, the stimuli may only be present in the microtissue chamber. The microtissue chamber is a closed and controlled environment, in which nutrients and waste only enter and exit from a controlled number of openings (ports) in the adjacent fluid-filled A-V channels. The flow of fluid is initially through the interstitial space, but as the microvessel network forms, the flow of fluid can divert to the living microvessels that are formed between the microfluidic and microtissue and within the microtissue itself. In yet another embodiment, the stimuli could be added to the ports.

Thus, the angiogenic stimuli are biologically-induced and can be both mechanical (interstitial flow and pressure) and chemical (e.g., VEGF, pH, or hypoxia) in nature. The microtissue compartment is comprised of either fibrin, type I collagen, or other biomimetic matrices (synthetic or naturally occurring) as well as a human stromal cell (e.g., fibroblast, mesenchymal stem cell), which is necessary for sustained lumen formation, and, in the present microfluidic platform, for facilitating a metabolic deficit. Other cells that could be used in the microtissue compartment, include but are not limited to, cardiac, liver, pancreas, connective tissue, nervous tissue, and muscle. In certain embodiments, the cells may comprise tumor cells, and more particularly, tumor cells or other cells derived specifically from individual subjects i.e. patient-specific tumor cells. In yet another embodiment, cardiomyocytes from human induced pluripotent stem cells (h-iPS) or cells derived from other stem cells or the stem cells themselves can be used to seed the stroma/tissue chambers. In another embodiment, another type of normal or diseased cells, obtained from an individual or patient, could be used in the microtissue compartment. A person of skill would appreciate that any combination of the aforementioned cells could also be used. Such cell types, and conditions to culture them, are known to those of skill in the art.

In one embodiment, a physiological pressure gradient within the microtissue compartment can be provided to initially induce limited nutrient fluid flow through the microtissue. As the microvessels sprout out from the microfluidic channels and grow towards the angiogenic stimulus, they eventually meet, anastomose, and deliver nutrients to the metabolizing microtissue. In short, the microfluidic platform mimics in vivo angiogenesis and vasculogenesis. Additional details on the cells, matrix, and microfabrication are discussed below.

The flow and pressure within the microfluidic channels and microtissue environments can be carefully controlled within physiologic and pathological ranges by manipulating either the inlet or outlet pressures and/or the design of the microfluidic network. Such manipulation of flow pressures can also be used as a stimulus to the microfluidic channel cells to produce the microvessels.

In one embodiment, the new microvessels are formed within the microtissue and then connect to the microfluidic channels. In an alternative embodiment, the newly formed microvessels grow/sprout from the microfluidic channels, grow into the microtissue, and connect with the microvessels that are growing in from the other side. In yet another embodiment, a combination of both of the former two microvessel growth paths can occur.

Different cell types can be used to seed/coat the “arteriole” and “venule” microfluidic channels, and the “microtissue” chamber. Various cell types (endothelial cells and stromal cells) can be utilized, with the goal of maximizing design flexibility. For instance, human endothelial cells can be seeded with a stromal cell in the microtissue chamber and microvessels can spontaneously form mimicking vasculogenesis. Alternatively, the microtissue chamber can be seeded with only stromal or other tissue-specific cells (e.g., cardiac) and microvessels can grow in from the “arteriole” and “venule” microfluidic channels, thus mimicking angiogenesis. The endothelial cells used to form the microvessels, which can be used to seed either the microfluidic channels, the microtissue compartment, and/or both, could come from a variety of sources including, but not limited to, human umbilical vein, aortic artery, microvasculature, or peripheral (or umbilical cord) blood-derived endothelial precursor cells. Stromal cells can also be used to help develop a stable in vitro perfused microvascular network, and both fibroblasts and mesenchymal stem cells have been demonstrated to be effective. We have utilized both primary lung and dermal fibroblasts, as well as fibroblast cell lines. In certain embodiments, the “venule” and “arteriole” microfluidic channels can be coated with the same endothelial cell type. In other embodiments, the “venule” and “arteriole” channels can be coated with cells known to be derived from venule or arteriole cells, or differentiated to express those phenotypes. Such cells are cultured under conditions well known to those of skill in the art.

In one embodiment, the microfluidic device as disclosed can be used to identify candidate drugs for instance, but not limited to drugs that invoke cell death (e.g., cancer cell death), or promote cell proliferation and extracellular matrix production (e.g., wound healing). Here, cancer cells could be seeded in the microtissue channel either before or after a microvessel network is established. The device or setup is amenable to anti-cancer drug screening through the introduction of potential drug candidates within either the microfluidic channels and/or microtissue at any particular stage of the microvessel network development process. The investigators would then be able to monitor whether there was a ‘beneficial’ effect on either the microvessels and/or microtissues. In another embodiment, the device allows for personalized analysis by allowing cells derived from specific healthy and/or diseased individuals to be seeded into the microtissue channel and/or microfluidic channel.

In another embodiment, the effect of chemical toxins or candidate toxins on the microcirculation can be determined using the disclosed device by delivering the toxin via the microfluidic channels and allowing the toxin to enter through formed microvessels or diffuse into the microtissue. Either the permeability of the chemical toxins across the microvessels or its direct toxicity on the microvessel network can be monitored or assessed. Microvessel or microtissue toxicity can be determined by conventional methods known to those of skill in the art, including the use of chemical assays; bioassays, and radioactive and imaging techniques.

In another embodiment, the most effective concentration of any particular drug could be determined by the disclosed device by monitoring the response of the microvessels, microtissue, or both to the drug's beneficial effects. The test compound would be delivered to the microtissue by diffusing from the microvessels or across the microtissue. The rate of delivery of the compound, and thus the optimum concentration within the microtissue depends on the desired response (i.e., increase or decrease in vessel network, cell proliferation or cell death, vessel robustness)

In another embodiment, the ability of a candidate drug that promotes cell proliferation or extracellular matrix production, or wound healing can be determined using the disclosed device. Here, The ‘beneficial effect’ with regards to this type of drug is on either the microvessels or microtissues—as deemed appropriate to those of skill in the art—but which can include, but is not limited to an increase in growth rate; increase microvessel network area; a change in the function of the cells; or any combination thereof.

In another embodiment, the drug kinetics could be determined by monitoring its kinetics i.e. diffusion rate from the microfluidic channels or microvessels into the microtissue.

The present invention features a microfluidic platform comprising a plurality of microfabricated microfluidic channels including a first microfabricated microfluidic channel and a second microfabricated microfluidic channel formed within a non-biological supportive material. The platform may further comprise one or more microfabricated compartments formed within the non-biological supportive material. The platform may further comprise cells combined with a biomimetic matrix and residing in at least one microfabricated compartment of the one or more microfabricated compartments. The platform may further comprise one or more living microvessels formed subsequent to the placement of the cells combined with the biomimetic matrix within the at least one microfabricated compartment. The one or more living microvessels may include a first living microvessel that connects to the first microfabricated microfluidic channel and the second microfabricated microfluidic channel. The first living microvessel may have a lumen and run from the first microfabricated microfluidic channel, through the at least one microfabricated compartment, and to the second microfabricated microfluidic channel, and the one or more living microvessels perfusing the cells combined with the biomimetic matrix and coupling together the plurality of microfabricated microfluidic channels. The one or more living microvessels may allow for delivery of a fluid flowing from the first microfabricated microfluidic channel of the plurality of microfabricated microfluidic channels to the cells combined with the biomimetic matrix. The fluid may flow inside the lumen of the one or more living microvessels, and wherein the one or more living microvessels are selected from a group consisting of (i) one or more living lymphatic vessels and (ii) one or more living blood vessels.

The process of fabricating the microfluidic platform enables a wide range of design variables to establish an in vitro perfused microvessel bed. Although, particular compounds or articles have been used for such fabrication of these perfused capillary structures, such as glass slides, parylene, SU-8, and PDMS, a person of skill in the art would appreciate that any equivalent article/compounds could be used such that they are compatible with cell viability and can be used in the microfabrication process.

In one embodiment (not shown), for the lymph vessel drain, parylene will be vapor-deposited over a photoresist sacrificial layer followed by a photolithography step to etch the holes that represent the lymph channels. After the photoresist is removed, a negative resist (SU-8) will be spin-coated and patterned by photolithography to establish the primary channels representing the microfluidic vessel channels (i.e. arteriole and venule). A second layer of SU-8 is then deposited to represent the arterio-venous communication ports that will sustain the capillary growth and fluid flow from arteriole to venule microfluidic channel via the microtissue in the microtissue chamber. Finally, a capping layer of polydimethylsiloxane (PDMS) is coated with a thin layer of SU-8 and bonded with the channel structures, which can correct for any unevenness which may occur from the multiple processing steps. Since PDMS is an elastomer and compliant it can generate an excellent seal as the thin layer of SU-8 is developed and exposed to UV light (similar to the process we have previously presented) 13. The resulting device contains a series of channels/compartments grouped in threes (“arteriole” channel, microtissue chamber, and “venule” channel) in which all physical dimensions are design variables. Each channel/compartment can be connected to one or more reservoirs that serve as the source of fluid during the construction of the tissue and growth of the capillary network. In one embodiment, these reservoirs are illustrated as the “bulb’ like structures at one or both ends of the arteriole/venule channels and microtissue chamber.

In one embodiment, following the fabrication of the PDMS device, the construction of the perfused microtissues can involve the following steps. A solution of collagen IV, collagen I, or appropriate matrix protein can be used to coat the arteriole, venule, and lymph vessel channels to mimic the basement membrane. A small volume of thrombin will then be added to a solution of fibrinogen, stromal cells, and/or endothelial cells, and immediately introduced into the microtissue matrix or microtissue chamber. If collagen or other biomimetic matrix is utilized, an alternate method of “gelling” or stiffening the matrix may be required. The cellularized “tissue” then clots or polymerizes (5-10 minutes). The presence of an air-liquid interface will create surface tension at the site of the ports and inhibit the flow of the solution into the arteriole, venule, or lymph vessel channels. Once coated with such matrix protein, the arteriole, venule, and lymph channels are seeded/coated with endothelial cells. Arteriole and venule fluid flow will then be introduced, and the cellularized tissue will be allowed to develop and remodel, including endothelial cell migration and microvessel formation.

Because the microtissue compartment can be a closed environment, the only source of nutrients will come from the surrounding channels/vessels. Thus, consistent with our biology-directed approach, the microtissues, for instance, the stromal cells, create a metabolic deficit (hypoxic, acidic, secretion of angiogenic growth factors) and thus a pro-angiogenic environment that will induce microvessel growth from the arteriole and/or venule channels to meet metabolic demands. Such induced microvessels will grow through the communication ports between the microtissue chamber and the arteriole and/or venule channels.

Device fabrication steps may include: 1) spin and pattern a sacrificial photoresist (4) onto a glass slide (2); 2) deposit parylene (6) on sacrificial photoresist; 3) etch holes in parylene (8) which will serve as drains for lymph) remove sacrificial photoresist to produce floating parylene membrane; 5) spin SU-8 onto glass and parylene and photopattern the microchannels (12) for passage of nutrients and flow between the microfluidic channels and through the microtissue; 6) cover top with a layer of PDMS (14) to seal device. The PDMS layer has holes for inlets and outlets.

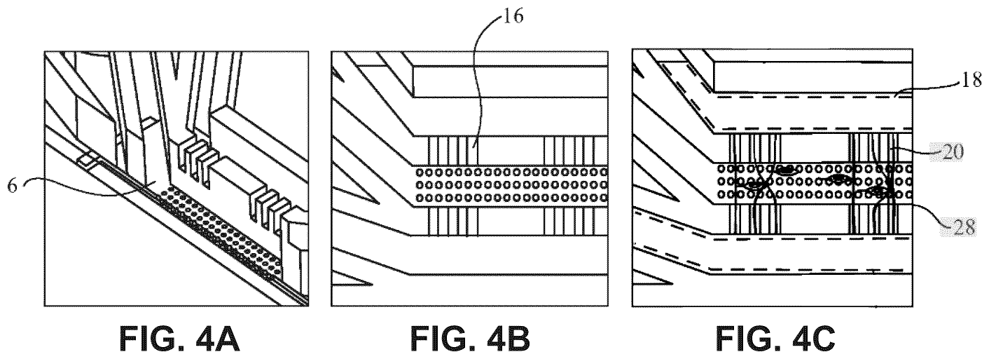

FIG. 4A shows a cut-away view of the microtissue channel highlighting the communication ports that will allow sprouting microvessels to penetrate tissue from either arteriole or venule channels, as well as the porous lower parylene layer (6) for lymph drainage. FIG. 4B shows a top view highlighting channels and communication ports (16). FIG. 4C shows venule (22) and arteriole (24) channels lined with collagen (I or IV) or fibronectin, and seeded with endothelial cells (18) which sprout through the channels—as microvessels (20)—to deliver nutrients to metabolizing tissue (stromal cells (28) in fibrin matrix) via the communication pores (16).

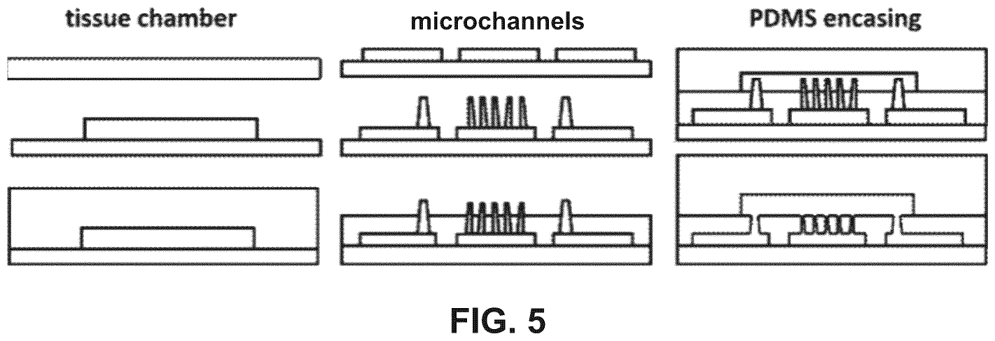

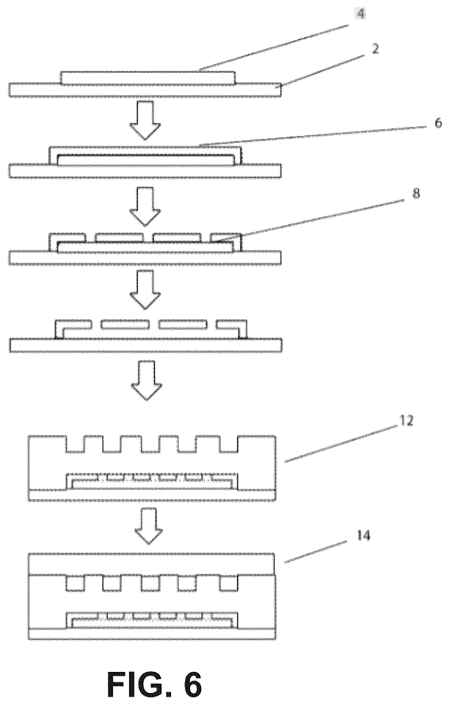

FIG. 5 shows another example of a scheme for the fabrication of an in vitro metabolically active microtissue. The basic steps in the fabrication of the microfluidic platform include: the Standard SU-8 photolithography process will be used to fabricate two micro-molds. First, a layer of SU-8 will be spin-coated onto a Si-wafer (RCA-1 cleaned and 2% HF treated). Then, a single mask photolithography step will pattern the tissue chamber. A similar SU-8 process will also be used to create molds for arteriole, lymph, and venule channels on another Si-wafer. The ports between the microtissue chamber and microfluidic channels will be created by spin-coating a second thick layer of SU-8 on the first layer. The porous bottom layer of the lymph channels is also created by this layer of SU-8 with a controlled diameter. The second mask is then used to align and pattern high aspect ratio posts for creating ports and a porous bottom layer. A 3 mm thick layer of PDMS will be molded on the SU-8 mold to create the microtissue chamber. A thin layer of PDMS will also be spun on the SU-8 molds for the arteriole, lymph, and venule channels and ports. The PDMS microtissue chamber is then de-molded and bonded to the spun PDMS thin film by using 02 plasma. The bonded multilayered PDMS device is then de-molded and holes punched to create an inlet/outlet to each channel (microtissue and microfluidic) before bonding to another 1 mm thick PDMS plate to seal channels. The main difference in this design scheme compared to that in FIG. 6 is the placement of the microtissue chamber on a different plane (at a different height). This allows the endothelial cells to develop over a flat surface in the fluidic channels and avoids sharp curvatures that appear to limit cell attachment.

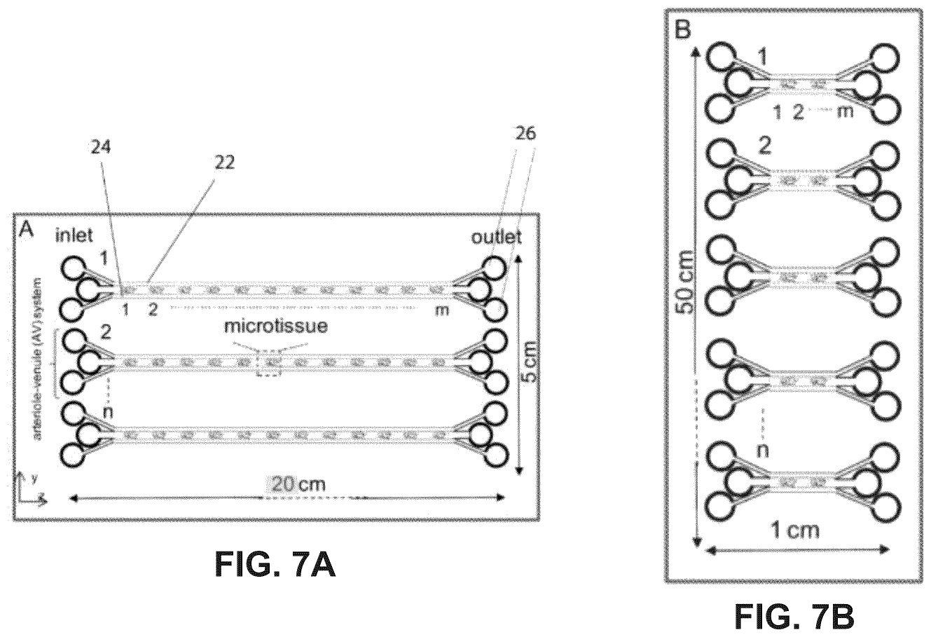

FIGS. 7A-7B show other embodiments for multiple design options for high-throughput are available including FIG. 7A) a relatively small (n=10) number of long (20 cm) arteriole-venule (A-V) systems on a single platform. In this design, significant gradients in diffusible species along the z-direction would develop. This would be useful to investigate a large range of concentrations of soluble species (e.g., oxygen, VEGF). In one embodiment, each A-V system (including reservoirs 26) will span approximately 5 mm in the y-direction. In addition, if the length of each microtissue compartment was 500 μm and the separation distance between microtissue was also 500 μm, each microtissue compartment would contain approximately m=200 microtissues. Thus, this platform could investigate the function of 2000 (m×n) similar or different types of microtissues. FIG. 7B) An alternative design representing a relatively large number (n=50) of much shorter (1 cm) A-V systems. This design would minimize spatial gradients in the z-direction and provide a greater number of observations of microtissues that are exposed to the feed (inlet) conditions (i.e., a concentration at z=0). In this case, there would be approximately m=10 microtissues along with each A-V system in the z-direction, and 100 AV systems in the y-direction, or 1000 (m×n) microtissues on a single platform. In FIGS. 7A and 7B, the venules are shown as 22, and the arterioles as 24.

Further examples include methods to control the pressure and flow in the microtissues (29). Long serpentine fluidic channels (30) can be strategically placed such that the pressure gradient is nearly constant across the individual microtissues (radial direction, z-axis), but significant along the microtissues (longitudinal direction, y-axis) or vice versa.

The microfluidic device was fabricated by standard polydimethylsiloxane micro-molding. The device consists of 2 fluid-filled microfluidic channels (arteriole and venule) on either side of a central metabolically active microtissue chamber consisting of normal human fibroblasts seeded (2×106 cells/ml) in a fibrin matrix. For the study of angiogenesis-like processes, human endothelial progenitor cell-derived endothelial cells (ECs) were used to line (1×106 cells/ml) the fluid-filled side channels (arteriole and venules) and allowed to migrate into and grow within the microtissue chamber via communicating ports (see FIG. 5). To simulate vasculogenic-like processes, in some devices, ECs were randomly distributed throughout the microtissue chamber with the fibroblasts. A pressure gradient (2 mm H2O) across the tissue chamber was applied once obvious network formation was identified. Flow in formed microvessels was assessed by adding 1 μm diameter polystyrene fluorescent beads into the microfluidic channels and tracking their movement in the formed microvessels across the tissue chamber. Multiphoton microscopy was used to image devices stained for CD31 markers (EC marker) and DAPI (nuclei stain).

In one embodiment, the three microfabricated compartments (arteriole channel, tissue chamber, and venule channel) can be formed so that all three are on the same horizontal level. In yet another embodiment, the arteriole and venule channels can be formed so that they are both at different levels to the tissue chamber, for instance, these channels are formed above the level of the microtissue chamber. In yet another embodiment, the arteriole and venule channels are not only at different levels from the microtissue chamber but also on different levels from each other.

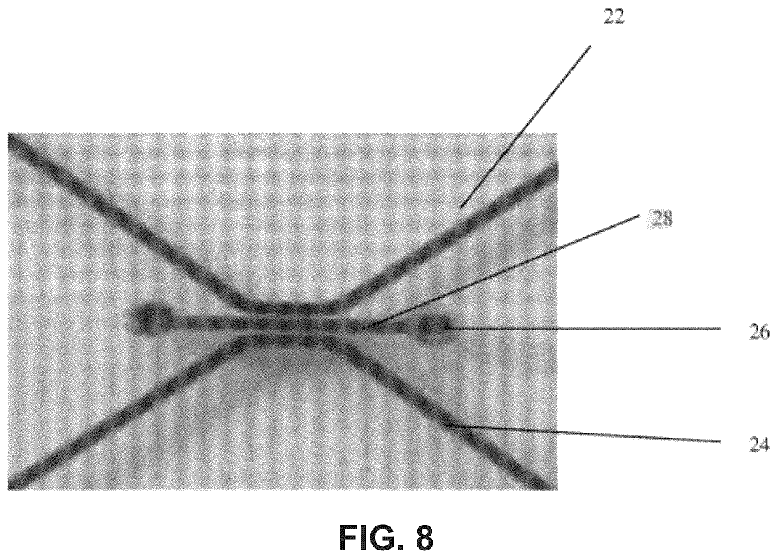

In one embodiment, the arteriole and venule channels do not have to run parallel throughout their entire lengths to the microtissue chamber. FIG. 8 shows a view of such a fabricated 3D cell system as viewed under a microscope. Here, only a small region of the venule channel (22) and arteriole channel (24) is shown running parallel to the microtissue chamber (28). Also shown are the reservoirs (26) for the microtissue chamber (reservoirs for the venules and arterioles are not depicted in this figure).

In yet another embodiment, the microtissue chamber can be alternate shapes (e.g., diamonds or tear-drops) rather than one long central microtissue channel/chamber (FIG. 9). This design facilitates the separation of the tissues by diffusion, although the microvessels may (but are not required to) still penetrate between the microtissue compartments for a fluidic connection.

Cells in the device remain viable under flow conditions for 40 days. For the device simulating angiogenesis, vacuoles consistent with early lumen formation were observed within a week of culture. When both endothelial cells and stromal cells are cultured in the microtissue chamber early perfusion of a partially formed vessel network was confirmed at 3 weeks and monitored through 40 days. Tracking microbeads introduced into the venule-like microfluidic channels reveal flow speed estimates of 35-200 μm/s. At day 40, 20 μl/day of fluid flow across the microtissue was recorded. Staining and imaging analysis confirmed the formation of tubules with lumens. (data not shown).

Additional details of the microfluidic device are disclosed in U.S. Pat. No. 9,810,685, and U.S. Provisional Application No. 63/226,069, filed Jul. 27, 2021, the specifications of which are incorporated herein in their entirety by reference.

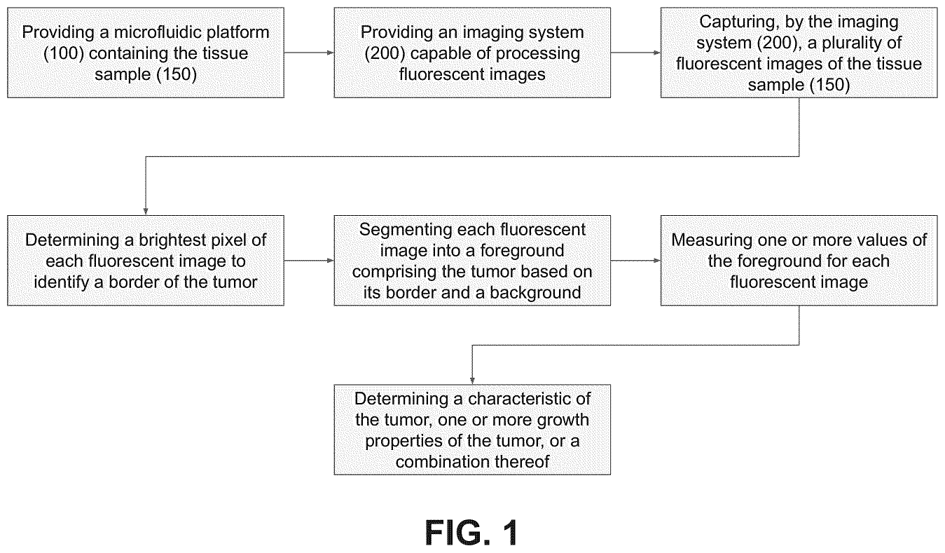

Referring now to FIG. 1, the present invention features a method for image-based data collection and analysis of a tissue sample (150) comprising a tumor. In some embodiments, the method may comprise providing a microfluidic platform (100) containing the tissue sample (150). The present invention may affect a shape of the tumor over a growth period such that certain tumors will grow into certain shapes. The difference in tumor size and shape may be determined more by the growth characteristic of the tumor type itself (e.g. tumor A is large and diffuse whereas tumor B is small and round) and the delivery of nutrients. Other parameters within the cell chamber may influence this growth (e.g. gel matrix).

In some embodiments, the specific structure of the microfluidic structure may affect a size, shape, intensity, volume, etc. of the tumor over the growth period. This may cause a tumor to grow into a simple form (e.g. circular, rounded), a complex form (e.g. jagged, fragmented), or a combination thereof depending on the type of tumor. The method may further comprise providing an imaging system (200) capable of processing fluorescent images, phase-contrast images, or a combination thereof, and directing a fluorescent dye through the microfluidic platform (100). The fluorescent dye may affect the tumor of the tissue sample (150) by illuminating it. In some embodiments, the tumors may express fluorescent proteins (e.g. green fluorescent protein, red fluorescent protein, blue fluorescent protein), which cause the tumors to be illuminated from within. In other embodiments, the delivery of dye through the platform is outside the cells to transiently deliver fluorescent signals outside the cells.

The fluorescent dye may be any kind of fluorescent dye (fluorescein, coumarin, cyanine, rhodamine, etc.). The method may further comprise capturing, by the imaging system (200), a plurality of fluorescent images of the tissue sample (150) over a period of time. The period of time may be on the order of minutes, days, or months. The period of time may at least encompass the growth period of the tumor. The method may further comprise a watershed imaging technique. The watershed imaging technique may comprise determining a brightest pixel of each fluorescent image to identify a border of the tumor for a watershed imaging technique. The pixel determined by this step may be the brightest point in the fluorescent image, representing the overall center of the tumor. The watershed imaging technique may further comprise traveling from this brightest pixel in multiple directions until a dark point is reached. The distance from the brightest pixel to the dark point may be specific to the type of tumor. For example, a lung tumor will have a 50-100 pixel distance from the center to the dark point. Knowing this, the algorithm for this imaging can be adjusted beforehand to most accurately image the specific type of tumor. This technique done in multiple directions establishes the border of the tumor. The method may further comprise segmenting, by the computing device (300), each fluorescent image into a foreground comprising the tumor and a background and measuring, by the computing device (300), for each fluorescent image, one or more values of the foreground comprising surface area, perimeter, centroid, bounding box, radius, diameter, and spatial moment. The method may further comprise determining, by the computing device (300), based on the one or more values of each fluorescent image of the plurality of fluorescent images, a characteristic of the tumor, one or more growth properties of the tumor, or a combination thereof.

In some embodiments, the method may further comprise applying a tumor treatment to the tissue sample (150) and determining, based on the plurality of fluorescent images, an efficacy of the tumor treatment by analyzing a change in geometry of the tumor over the period of time. For example, small molecule drugs, immunotherapies, or genetic modifications may be applied to the tissue sample (150), and a change in size, shape, volume, intensity, and/or fragmentation may be monitored over the period of time. The method may further comprise determining, based on the plurality of fluorescent images, a growth of the tumor over the period of time. In some embodiments, the imaging system (200) may comprise a microscope system (e.g. an automated fluorescent microscope), a plate reader with imaging capacity, a camera, or a combination thereof. Identifying the shape of the tumor may comprise executing, by the computing device (300), a machine learning algorithm trained by previous data mapping types of tumors to shapes of tumors. In some embodiments, the computing device (300) may comprise a processor capable of executing computer-readable instructions and a memory component comprising a plurality of computer-readable instructions. The characteristic may comprise a type of tumor, a size of the tumor, a shape of the tumor, an intensity of the tumor, and a volume of the tumor.

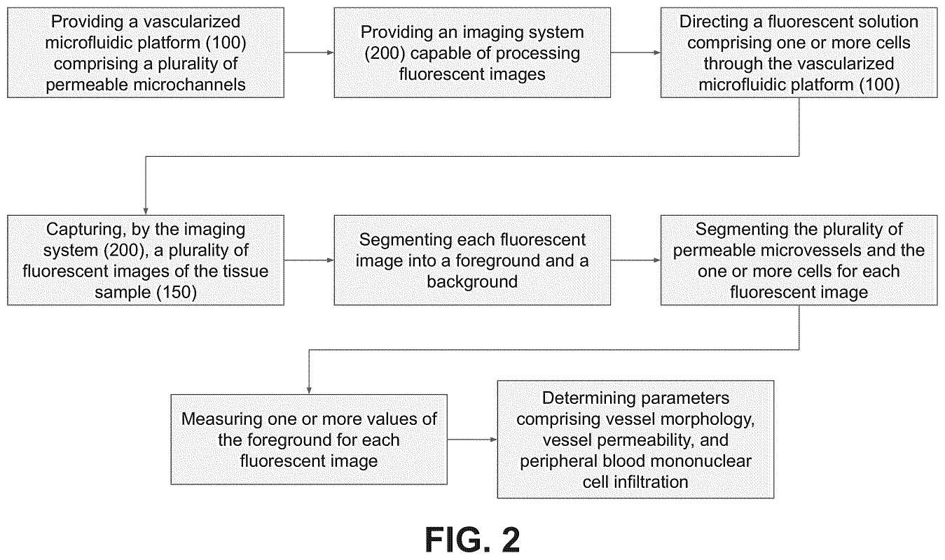

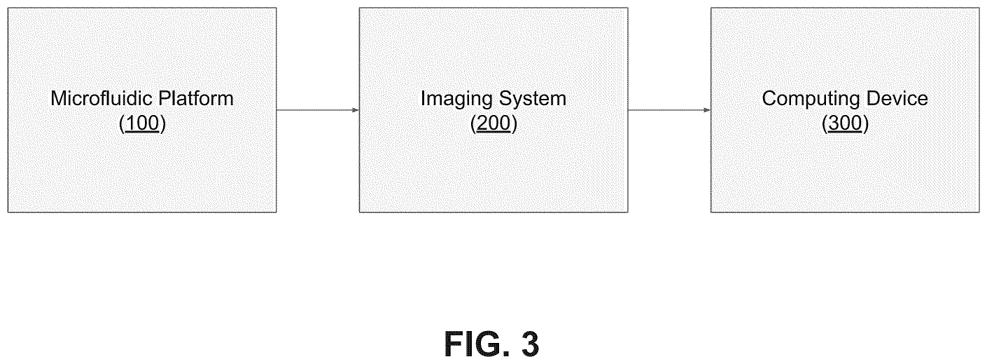

Referring now to FIG. 2, the present invention features a method for image-based data collection and analysis of simulated blood vessels. In some embodiments, the method may comprise providing a vascularized microfluidic platform (100) comprising a plurality of permeable microchannels. The plurality of permeable microchannels may comprise the simulated blood vessels. Each microchannel may have a permeability similar to or equivalent to that of an in vivo blood vessel. The method may further comprise providing an imaging system (200) capable of processing fluorescent images and directing a fluorescent solution comprising one or more cells through the vascularized microfluidic platform (100). The fluorescent solution may at least partially permeate through the plurality of permeable microchannels in a manner similar to the permeation of fluid through in vivo blood vessels. The method may further comprise capturing, by the imaging system (200), a plurality of fluorescent images of the plurality of permeable microchannels over a period of time. The method may further comprise segmenting, by the computing device (300), each fluorescent image into a foreground comprising the plurality of permeable microvessels and the one or more cells, and a background. The method may further comprise segmenting, by the computing device (300), for each fluorescent image, the plurality of permeable microvessels, and the one or more cells. The method may further comprise measuring, by the computing device (300), for each fluorescent image, one or more values of the foreground comprising total vessel network area, total vessel length, number of branch points, lacunarity, a number of cells inside the plurality of permeable microvessels, and a number of cells outside the plurality of permeable microvessels. The method may further comprise determining, by the computing device (300), based on the one or more values of each fluorescent image of the plurality of fluorescent images, one or more parameters comprising a morphology of the microfluidic platform (100), a molecular exchange rate of each microvessel, a metabolic exchange rate of each microvessel, cell movement, and tissue infiltration of the one or more cells.

In some embodiments, the plurality of permeable microchannels may be endothelialized. The one or more cells may comprise any kind of blood-borne cells (e.g. lymphocytes, tumor cells, metastasizing cancer cells, white blood cells, red blood cells, platelets, stem cells, etc.). The imaging system (200) may comprise an automated fluorescent microscope system, a plate reader with imaging capacity, or a combination thereof. The computing device (300) may comprise a processor capable of executing computer-readable instructions and a memory component comprising a plurality of computer-readable instructions. In some embodiments, the method may further comprise simulating, in the vascularized microfluidic platform (100), an inflammation signal through use of an inflammatory cytokine, and determining, by the computing device (300), based on the plurality of fluorescent images, a response to the inflammation signal by the cells (e.g. adhesion to the vessel wall, extravasation into extravascular space, etc.). The platform can be used to test novel drugs for wanted or unwanted vasoactive effects on the blood vessels. The platform can also be used to test responses to an increase in blood pressure. In some embodiments, the platform may be compact, as small as palm-sized.

In some embodiments, cells, and any combinations thereof, may be engineered to constitutively express fluorescent proteins in MPS for live imaging purposes. The present invention may be capable of imaging and identifying tumor size and shape, vascular morphometry (vessel length, vessel area, number of branch points, diameter, etc.), and co-localization of cells, in any combinations thereof, and engineered proteins with fluorescent tags. Because of the uniquely organic model of blood vessels in the microfluidic platform, the present invention is capable of directly counting how many white blood cells adhere to the blood vessel wall and exit the blood vessels in response to an inflammation signal accurately without needing to view the process in vivo. This allows the present invention to accurately simulate and visualize the way that white blood cells travel through blood vessels to reach inflamed tissue in the body in response to an inflammation signal. Additionally, the present invention is capable of counting and tracking cancer cells' movement in and out of the vessel walls through a series of time-lapse images to study cancer metastasis. This allows the present invention to accurately simulate and visualize metastasizing cancer cells from a tissue invading the vessel wall, traveling through the blood vessels, and exiting and colonizing a new tissue site.

In some embodiments, the method may further comprise generating, by the computing device (300), for each fluorescent image, a probability map of the plurality of microvessels and the one or more cells, and comparing, by the computing device (300), the plurality of probability maps to track cell movement and count the number of cells inside the plurality of permeable microvessels and the number of cells outside the plurality of permeable microvessels. The method may further comprise training a machine learning algorithm with the foreground and the background of the plurality of fluorescent images. Generating the plurality of probability maps may comprise executing the machine learning algorithm.

In some embodiments, the method may further comprise aligning, by the computing device (300), the plurality of fluorescent images into a stack, selecting, by a user, one or more regions of interest (ROI) of the plurality of fluorescent images, measuring, by the computing device (300), a fluorescent intensity of the one or more ROIs of the plurality of fluorescent images over the period of time, and determining, by the computing device (300), a permeability of the plurality of microvessels at the one or more ROIs. In some embodiments, the method may further comprise executing a skeletonization algorithm to segment each fluorescent image into the foreground and the background.

The present invention features a computer system for image-based data collection and analysis of a tissue sample (150) comprising a plurality of microvessels. In some embodiments, the computer system may comprise an imaging system (200) capable of processing fluorescent images, a processor capable of executing computer-readable instructions, and a memory component comprising a plurality of computer-readable instructions. The instructions may comprise capturing, by the imaging system (200), a plurality of fluorescent images of the tissue sample (150) over a period of time. The tissue sample (150) may be disposed in a microfluidic platform (100). The instructions may further comprise segmenting each fluorescent image into a foreground comprising the tissue sample, and a background, and detecting, by the computing device (300), if a tumor exists in the tissue sample. The instructions may further comprise measuring, by the computing device (300), if the tumor was detected, for each fluorescent image, one or more tumor values of the foreground comprising surface area, perimeter, centroid, bounding box, radius, diameter, and spatial moment. The instructions may further comprise measuring, by the computing device (300), for each fluorescent image, one or more vessel values of the foreground comprising total vessel network area, total vessel length, number of branch points, lacunarity, a number of cells inside the plurality of permeable microvessels, and a number of cells outside the plurality of permeable microvessels. The instructions may further comprise determining, by the computing device (300), based on the one or more tumor values and the one or more vessel values of each fluorescent image of the plurality of fluorescent images, one or more parameters comprising a morphology of the microfluidic platform (100), a molecular exchange rate of each microvessel, a metabolic exchange rate of each microvessel, cell movement, and tissue infiltration of the one or more cells.

The present invention is able to process raw fluorescent images of cancer cells in a microfluidic platform, identify tumor clusters, and perform various measurements for these identified clusters. In some embodiments, the tumors and tissue implemented in the presently claimed invention may utilize human tissue, tumors, cells, etc. The present invention first takes raw fluorescent images of cancer cells and corrects the illumination and enhances the edge of tumor clusters. It then applies a watershed transformation to segment the foreground (tumor clusters) and the black background. Once the tumor clusters have been segmented into individual objects, the pipeline will perform various measurements and generate a tabulated data frame (.csv file format). Measurements include, but are not limited to surface area (individual clusters and total), perimeters, centroid, shape (bounding box), radius/diameter, and spatial moment. By performing these measurements on a series of time-course images, tumor growth or reduction in response to therapeutic treatment in the platform can be quantified. Note that for properties such as tumor type, geometry, size, etc., only an initial image of the tumor is needed. Measuring tumor growth properties and responses to drugs, however, requires a plurality of images taken over a period of time. This method may be used for testing the efficacy of drugs on tumors by seeing how the shape changes over time with the application of a treatment, data mining for training machine learning models to identify tumors in in vivo models, and providing tumor models for research purposes without the need for a living specimen. Obviating a living model provides greater visualization, time efficiency, and cost efficiency over prior systems.

The present invention features a system comprising a microfluidic platform (100) with a tissue sample (150) comprising a tumor and an analysis system for image-based data collection and analysis of the tissue sample (150) comprising the tumor. In some embodiments, the analysis system may comprise an imaging system (200) for obtaining fluorescent images at one time point or a series of time points, and a processor capable of executing computer-readable instructions and a memory component comprising a plurality of computer-readable instructions. The plurality of computer-readable instructions may comprise one or a combination of capturing a plurality of fluorescent images of the tissue sample (150) over a period of time by the imaging system (200), determining a brightest pixel of each fluorescent image to identify a border of the tumor, segmenting each fluorescent image into a foreground comprising the tissue sample, and a background, detecting if a tumor exists in the tissue sample, measuring one or more tumor values of the foreground for each fluorescent image if the tumor was detected, measuring one or more vessel values of the foreground for each fluorescent image, and determining one or more parameters comprising a type of tumor, vessel morphology, vessel permeability, and peripheral blood mononuclear cell exchange based on the one or more tumor values and the one or more vessel values of each fluorescent image of the plurality of fluorescent images. The system may determine a characteristic of the tumor, one or more growth properties of the tumor, or a combination thereof.

The present invention is able to process raw fluorescent images of peripheral blood mononuclear cells (PBMC) and vessel network in a microfluidic platform, count PBMC, and determine whether they are located inside (adherent PBMC) or outside (extravasated PBMC) of the vessel network. In other words, the present invention is capable of determining a molecular exchange rate of each microvessel, a metabolic exchange rate of each microvessel, cell movement, and tissue infiltration of one or more cells. In the first stage, the present invention lets a user use brush strokes to define the foreground (PBMC or vessel network) and the black background on a fluorescent image and use this information as the training input for its machine learning algorithm. The present invention then takes this training and applies it to all images to segment the objects (PBMC or vessel network) and generate probability maps for them. In the second stage, the present invention uses the PBMC and vessel network probability maps to count and determine whether there is an overlapping signal between the two maps. If there is an overlapping signal (i.e. one PBMC located inside a vessel segment), the present invention will count it as an adherent PBMC. If a PBMC signal falls outside of a vessel segment, the present invention will count it as an extravasated PBMC. This method may be used for researching adhesion/extravasation of PBMCs out of the vessels, migration of PBMCs towards a tumor, and invasion into a tumor (occupancy).

In some embodiments, the PBMCs come from specific donors, either through an in-house biobank or provided by clients for specific applications. Blood cells are typically stained with a membrane-permeable fluorescent dye, so they can be visualized under fluorescent microscopy.

The present invention is capable of determining a response to an inflammation signal by one or more cells. This may comprise directing a fluorescent fluid comprising one or more cells through the plurality of microvessels of the microfluidic platform (100) and simulating an inflammation signal through manipulation of an area in the plurality of microvessels. This may further comprise tracking cell movement through the probability map method outlined in the previous paragraph to determine how the one or more cells respond and move in response to an inflammation signal.

The present invention is able to process a series of images of fluorescent dye perfusing through the vascular network in a microfluidic platform and quantify the amount of dye leak in the extravascular space. In other words, the present invention is capable of determining a permeability of the plurality of microvessels at one or more ROIs. The present invention first aligns the time-lapse images into a stack and lets users click on the extravascular spaces to define circular regions of interest (ROI). It then applies these ROIs to all images within the aligned stack. The fluorescent intensity in these ROIs is automatically measured and pair-matched to track changes over time. The net difference is calculated to determine the amount of dye leak through the vascular network over time.

The present invention is able to process fluorescent images of a vascular network in a microfluidic platform and quantify vascular morphometry parameters such as total vessel network area, total vessel length, number of branchpoint, and lacunarity. In other words, the present invention is capable of determining a morphology of the microfluidic platform (100). The present invention applies a skeletonization algorithm to the fluorescent image of the vascular network to generate a skeleton image. A skeletonization algorithm comprises identifying an area of brightness and thinning each region by iteratively deleting border pixels without breaking the connectivity of neighboring pixels so that only the skeletonized image remains. It then performs measurements on this skeletonized image to determine vessel morphometry parameters.

In some embodiments, the watershed method for determining a border of the tumor in a fluorescent image may comprise selecting one or more pixels adjacent to the brightest pixel to determine one or more selected pixels, checking the one or more selected pixels for the dark point, and selecting, for each pixel of the one or more pixels, one or more subsequent pixels adjacent to the pixel. The one or more subsequent pixels may be reassigned to be the one or more selected pixels, and repeating checking and selection until the dark point is found.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A method for image-based data collection and analysis of a tissue sample (150) comprising a tumor, the method comprising:
a. providing a microfluidic platform (100) containing the tissue sample (150);
b. providing an imaging system (200) capable of processing fluorescent images;
c. capturing a plurality of fluorescent images of the tissue sample (150) over a period of time with the imaging system (200);
d. determining a brightest pixel of each fluorescent image, wherein the brightest pixel signifies a center of the tumor;
e. determining, for each fluorescent image, a border of the tumor based on an iterative search from the brightest pixel to a dark point of each fluorescent image, the iterative search comprising:
i. selecting one or more pixels adjacent to the brightest pixel to determine one or more selected pixels;
ii. checking the one or more selected pixels for the dark point;
iii. selecting, for each pixel of the one or more pixels, one or more subsequent pixels adjacent to the pixel, wherein the one or more subsequent pixels are reassigned to be the one or more selected pixels; and
iv. repeating steps ii-iii until the dark point is found;
f. segmenting each fluorescent image into a foreground comprising the tumor based on the border of the tumor and a background;
g. measuring one or more values of the foreground for each fluorescent image, the one or more values comprising the shape of the tumor; and
h. determining a characteristic of the tumor, one or more growth properties of the tumor, or a combination thereof based on the one or more values of each fluorescent image of the plurality of fluorescent images.

2. The method of claim 1 further comprising:
a. applying a tumor treatment to the tissue sample (150); and
b. determining an efficacy of the tumor treatment by analyzing a change in geometry of the tumor over the period of time based on the plurality of fluorescent images.

3. The method of claim 1 further comprising determining a growth of the tumor over the period of time based on the plurality of fluorescent images.

4. The method of claim 1, wherein the imaging system (200) comprises a microscope system, a plate reader, a camera, or a combination thereof.

5. The method of claim 1, wherein identifying the shape of the tumor comprises executing a machine learning algorithm.

6. The method of claim 5, wherein the machine learning algorithm is trained by previous data mapping types of tumors to shapes of tumors.

7. The method of claim 1, wherein the computing device (300) comprises a processor capable of executing computer-readable instructions and a memory component comprising a plurality of computer-readable instructions.

8. The method of claim 1 further comprising directing a fluorescent dye through the microfluidic platform (100), wherein the fluorescent dye illuminates the tumor of the tissue sample (150).

9. The method of claim 1, wherein the one or more values comprise surface area, perimeter, centroid, bounding box, radius, diameter, spatial moment, volume, and gray value intensity.

10. The method of claim 1, wherein the characteristic of the tumor comprises a type of tumor, a size of the tumor, an intensity of the tumor, and a volume of the tumor based on the one or more values of each fluorescent image of the plurality of fluorescent images.

11. The method of claim 10, wherein the type of tumor is determined by the border of the tumor and a diameter of the border of the tumor.

12. The method of claim 11, wherein a diameter of the border of the tumor is 50 to 100 pixels for a lung tumor, 200 to 300 pixels for a breast tumor, and 50 to 200 pixels for a colon tumor.

13. The method of claim 1, wherein the method is used for testing efficacy of drugs on tumors, data mining for training machine learning models, and providing tumor models without the need for a living specimen.

14. A method for image-based data collection and analysis of simulated blood vessels, the method comprising:
a. providing a vascularized microfluidic platform (100) comprising a plurality of microchannels comprising a plurality of permeable microvessels, wherein the plurality of permeable microvessels comprise the simulated blood vessels, wherein each microvessel has a permeability of an in vivo blood vessel;
b. providing an imaging system (200) capable of processing fluorescent images;
c. directing a fluorescent solution comprising one or more cells through the vascularized microfluidic platform (100);
d. capturing a plurality of fluorescent images of the plurality of permeable microvessels over a period of time by the imaging system (200);
e. segmenting each fluorescent image into a foreground comprising the plurality of permeable microvessels and the one or more cells, and a background;
f. segmenting the plurality of permeable microvessels and the one or more cells for each fluorescent image;
g. measuring one or more values of the foreground for each fluorescent image; and
h. determining one or more parameters comprising vessel morphology, vessel permeability, and peripheral blood mononuclear cell infiltration based on the one or more values of each fluorescent image of the plurality of fluorescent images.

15. The method of claim 14, wherein the plurality of permeable microvessels are endothelialized.

16. The method of claim 14, wherein the one or more cells comprise white blood cells.

17. The method of claim 14, wherein the one or more cells comprise metastasizing cancer cells.

18. The method of claim 14, wherein the imaging system (200) comprises a microscope system, a plate reader, a camera, or a combination thereof.

19. The method of claim 14, wherein the computing device (300) comprises a processor capable of executing computer-readable instructions and a memory component comprising a plurality of computer-readable instructions.

20. The method of claim 14 further comprising:
a. simulating an inflammation signal in the vascularized microfluidic platform (100); and
b. determining a response to the inflammation signal by the cells based on the plurality of fluorescent images.

21. The method of claim 14 further comprising:
a. generating a probability map of the plurality of microvessels and the one or more cells for each fluorescent image; and
b. comparing the plurality of probability maps to track cell movement and count the number of cells inside the plurality of permeable microvessels and the number of cells outside the plurality of permeable microvessels.

22. The method of claim 21 further comprising:
a. training a machine learning algorithm with the foreground and the background of the plurality of fluorescent images;
wherein generating the plurality of probability maps comprises executing the machine learning algorithm.

23. The method of claim 14 further comprising:
a. aligning the plurality of fluorescent images into a stack;
b. selecting one or more regions of interest (ROI) of the plurality of fluorescent images by a user;
c. measuring a fluorescent intensity of the one or more ROIs of the plurality of fluorescent images over the period of time; and
d. determining a permeability of the plurality of microvessels at the one or more ROIs.

24. The method of claim 14 further comprising executing a skeletonization algorithm to segment each fluorescent image into the foreground and the background.

25. The method of claim 14, wherein the one or more values comprise total vessel network area, total vessel length, number of branch points, lacunarity, a number of cells inside the plurality of permeable microvessels, and a number of cells outside the plurality of permeable microvessels.

26. The method of claim 14, wherein the one or more parameters further comprise a molecular exchange rate of each microvessel, a metabolic exchange rate of each microvessel, cell movement, and tissue infiltration of the one or more cells.

27. A computer system for image-based data collection and analysis of a tissue sample (150) comprising a plurality of microvessels, the computer system comprising:
a. an imaging system (200) capable of processing fluorescent images;
b. a processor capable of executing computer-readable instructions; and
c. a memory component comprising a plurality of computer-readable instructions for:
i. capturing a plurality of fluorescent images of the tissue sample (150) over a period of time by the imaging system (200), wherein the tissue sample (150) is disposed in a microfluidic platform (100);
ii. determining a brightest pixel of each fluorescent image to identify a border of the tissue sample;
iii. segmenting each fluorescent image into a foreground comprising the tissue sample, and a background;
iv. detecting if a tumor exists in the tissue sample;
v. measuring one or more tumor values of the foreground for each fluorescent image if the tumor was detected;
vi. measuring one or more vessel values of the foreground for each fluorescent image; and
vii. determining one or more parameters comprising a type of tumor, vessel morphology, vessel permeability, and peripheral blood mononuclear cell exchange based on the one or more tumor values and the one or more vessel values of each fluorescent image of the plurality of fluorescent images.

28. The method of claim 27, wherein the one or more tumor values comprise surface area, perimeter, centroid, bounding box, radius, diameter, spatial moment, volume, and gray value intensity.

29. The method of claim 27, wherein the one or more vessel values comprise total vessel network area, total vessel length, number of branch points, lacunarity, a number of cells inside the plurality of permeable microvessels, a number of cells outside the plurality of permeable microvessels, vessel diameter, vessel constriction, and vessel expansion.

30. The method of claim 27, wherein the one or more parameters further comprise a size of the tumor, a shape of the tumor, an intensity of the tumor, a volume of the tumor, a molecular exchange rate of each microvessel, a metabolic exchange rate of each microvessel, cell movement, and tissue infiltration of the one or more cells.

31. A system comprising:
a. a microfluidic platform (100) with a tissue sample (150) comprising a tumor; and
b. an analysis system for image-based data collection and analysis of the tissue sample (150) comprising the tumor, said analysis system comprising:
an imaging system (200) for obtaining fluorescent images at one time point or a series of time points; and
a processor capable of executing computer-readable instructions and a memory component comprising a plurality of computer-readable instructions for one or a combination of:
(i) capturing a plurality of fluorescent images of the tissue sample (150) over a period of time by the imaging system (200);
(ii) determining a brightest pixel of each fluorescent image to identify a border of the tumor;
(iii) segmenting each fluorescent image into a foreground comprising the tissue sample, and a background;
(iv) detecting if a tumor exists in the tissue sample;
(v) measuring one or more tumor values of the foreground for each fluorescent image if the tumor was detected;
(vi) measuring one or more vessel values of the foreground for each fluorescent image; and
(vii) determining one or more parameters comprising a type of tumor, vessel morphology, vessel permeability, and peripheral blood mononuclear cell exchange based on the one or more tumor values and the one or more vessel values of each fluorescent image of the plurality of fluorescent images;
wherein the system can determine a characteristic of the tumor, one or more growth properties of the tumor, or a combination thereof.
